(19) United States
(12) Patent Application Publication
(10) Pub. No.: US 2026/0358469 A1
(43) Pub. Date: Nov. 12, 2026

(54) METHOD FOR DETERMINING A POSITION AND/OR A SPEED OF AN OBJECT IN ROAD TRAFFIC

(71) Applicant: FTES AG, Erlenbach (CH)

(72) Inventor: Gabriel Schnoering, Maennedorf (CH)

(21) Appl. No.: 19/486,707

(22) PCT Filed: May 15, 2024
(86) PCT No.: PCT/EP2024/063426

§ 371 Date: Nov. 21, 2025

(30) Foreign Application Priority Data
May 24, 2023 (DE) 10 2023 113 663.1
Jul. 28, 2023 (DE) 10 2023 120 121.2

(51) Int. Cl. G01S 7/35; G01S 13/34; G01S 13/58; G01S 13/931

(52) U.S. Cl. CPC G01S 7/356; G01S 13/343; G01S 13/584; G01S 13/931

(57) ABSTRACT

A method, in particular a computer-implemented method, for determining a position, in particular direction and/or distance, and/or a speed of an object in road traffic by means of a radar unit in a vehicle, utilizes an antenna unit having a plurality of antenna elements, wherein the antenna elements are arranged in an irregular pattern. The method includes emitting output signals with the aid of the irregularly arranged antenna elements and receiving reflection signals with the aid of the irregularly arranged antenna elements. The method also includes, in order to determine the position and/or the speed of the object, evaluating the received reflection signals using a non-uniform Fourier transform that can evaluate signals, in particular the captured reflection signals, from the antenna elements arranged in the irregular pattern.

### CROSS-REFERENCE TO RELATED APPLICATIONS

The present application is a national phase entry of International Patent Application No. PCT/EP2024/063426, filed on May 15, 2024, which, in turn, is based upon and claims the right of priority to German Patent Application No. 10 2023 113 663.1, filed on May 24, 2023, and Germany Patent Application No. 10 2023 120 121.2, filed Jul. 28, 2023, the disclosures of which are hereby incorporated by reference herein in their entirety for all purposes.

### FIELD OF THE INVENTION

The present subject matter relates to a method, in particular a computer-implemented method, for determining a position, in particular direction and/or distance, and/or a speed of an object in road traffic by means of a radar unit in a vehicle, in which an antenna unit having a plurality of antenna elements is used, the antenna elements being arranged in an irregular pattern, wherein output signals are emitted with the aid of the irregularly arranged antenna elements, wherein reflection signals are captured with the aid of the irregularly arranged antenna elements, and wherein, in order to determine the position and/or the speed of the object, the captured reflection signals are evaluated by means of a non-uniform Fourier transform that can evaluate the signals, especially the captured reflection signals, of the antenna elements arranged in the spatially irregular pattern.

### BACKGROUND

Radar systems are known that have a plurality of antenna elements with which signals are emitted and received. However, the number of the antenna elements is quite high.

Advanced driver-assistance systems (ADAS) are intended to improve the safety of the driver and to enable autonomous driving. Ultimately, such systems aim to enable autonomous driving. The most important sensor technologies include ultrasound, LiDAR, cameras, and radar. LiDAR and cameras deliver high-resolution images but have problems in adverse weather conditions, whereas radar is in fact more robust but has lower image quality due to the low angular resolution. In order to increase the feasibility of radar systems for autonomous driving, large physical apertures are needed, which is a challenge when enlarging the aperture of radar arrays.

A typical frequency-modulated continuous wave (FMCW) radar achieves high angular resolution using a large aperture. Antenna elements of the radar system, or of a radar unit, normally form uniform linear arrays (ULA) separated by half the wavelength, which, however, results in arrays having hundreds of antenna elements.

Reducing the number of the elements without changing the aperture results in sparse arrays. The design of such arrays has gained attention, since the antenna elements are strategically positioned to avoid an ambiguous detection.

### SUMMARY

In various aspects, the problem addressed by the present subject matter relates to the reduction of the number of antenna elements in a radar system. This can allow, for example, an object in road traffic to be more reliably detected.

In various aspects, the problem is solved by a method, a radar unit, a vehicle, a computer program, and a computer-readable storage medium having the features described and/or claimed herein.

In one aspect, the present subject matter relates to a method, in particular a computer-implemented method, for determining a position and/or a speed of an object in road traffic by means of a radar unit in a vehicle. The radar unit can also be a vehicle radar unit. The position of the object can be, for example, a direction and/or distance. Direction and/or distance can be related with respect to the radar unit or the vehicle. The direction means, for example, that it is possible to establish whether the object is located ahead of the vehicle or to the left or right of the vehicle. The distance is also measured, or determined, to the radar unit and thus to the vehicle. By determining the position and/or a speed of an object in road traffic, driving safety is increased and accidents are avoided. The method described here can thus be used in driver assistance systems. The objects can also be other road users, such as other automobiles, trucks, bicycles, pedestrians, or solid objects such as trees, posts or columns, etc. The radar unit can be located, for example, in a bumper, in particular in a front and/or rear region of the vehicle, and/or in another vehicle component. The driver assistance systems are also referred to in English as “advanced driver-assistance systems”, or abbreviated as ADAS.

In the method, an antenna unit having a plurality of antenna elements is used, wherein the antenna elements are arranged in an irregular pattern. Moreover, the antenna elements are sparsely arranged. This means that fewer antenna elements are present in comparison to antenna units having antenna elements that are arranged in a regular pattern. These types of antenna units are referred to in English as “sparse (antenna) arrays.” If the antenna elements are arranged, for example, in a regular pattern, then these are all arranged, for example, at a distance from one another corresponding to half the wavelength of output signals.

Furthermore, in the method, output signals are emitted with the aid of the irregularly and/or sparsely arranged antenna elements. The output signals are electromagnetic waves in this case.

In addition, in the method, reflection signals are captured with the aid of the irregularly and/or sparsely arranged antenna elements. After the output signals have been emitted, they hit objects when objects are present. The electromagnetic waves are reflected on the object, and reflection signals are reflected back to the antenna unit. These reflection signals are captured by the antenna elements arranged in the irregular and/or sparse pattern.

Furthermore, in the method, the captured reflection signals are evaluated by means of a non-uniform Fourier transform in order to determine the position and/or the speed of the object. The non-uniform Fourier transform can evaluate the reflection signals captured by the antenna elements arranged in the spatially irregular pattern. The non-uniform Fourier transform is also referred to in English as a “non-uniform Fourier transform.” With the aid of the non-uniform Fourier transform, or a non-uniform fast and/or discrete Fourier transform, a tool is provided which can evaluate the reflection signals at a sufficient speed, wherein the reflection signals have been captured by the antenna elements in the irregular and/or sparse pattern. The non-uniform fast and/or discrete Fourier transform is also referred to as non-uniform fast Fourier transform (nuFFT). The position and/or the speed of the object is determined by means of a corresponding algorithm.

An improvement results when an antenna unit is used in which the antenna elements are arranged on grid points of a grid, in particular of a two-dimensional grid, wherein some grid points are unoccupied.

It is useful when grid points arranged next to one another have a spacing λ/2.

It is advantageous when the antenna elements are arranged in a circle around the grid points, wherein the circle amounts to a radius of 5%-20% of λ/2.

It is advantageous when the antenna elements are arranged in such a way that the array, or the arrangement of the antenna elements, delivers an unambiguous response and preferably corresponds to or comes close to the grid points, wherein some elements are unoccupied. The grid spacing is preferably λ/2.

It is advantageous when the antenna elements are arranged in such a way that they deliver unambiguous results, in particular according to the non-uniform fast Fourier transform. In this case, no further signal peaks other than those of objects are to be generated.

It is beneficial when an antenna unit having a sparsely occupied grid is used. In addition, an antenna unit having a sparse distribution of the antenna elements can be used. The antenna elements preferably match a sparsely filled/populated grid.

Advantages are provided when positions of the antenna elements are stored in a data store and the positions of the antenna elements are retrieved from the data store to carry out the non-uniform Fourier transform. The positions of the antenna elements are related with respect to a reference point, for example a center of the antenna unit. The positions of the antenna elements can be used as parameters for the non-uniform fast Fourier transform, or the corresponding algorithm. The positions of the antenna elements allow the non-regularity of the antenna elements to be taken into account for the determination of the position and/or the distance of the objects.

It is beneficial when the direction, in particular an angle, of the object relative to the antenna unit is determined with the aid of the non-uniform Fourier transform and the antenna elements arranged in the irregular pattern.

Advantages are provided when a distance of the object from the antenna unit is determined with the aid of the non-uniform Fourier transform and the antenna elements arranged in the irregular pattern.

It is beneficial when a non-uniform fast Fourier transform algorithm is applied to determine the position, in particular the direction, and/or the distance of the object.

Advantages are provided when the antenna elements are operated by means of a multiple-input multiple-output (MIMO) method.

It is useful when an antenna unit is used, which has antenna elements arranged in such a way that, in the case of a virtual arrangement of the antenna elements, all antenna elements are spaced apart from one another. The antenna elements in the array, or in the antenna unit, are arranged in such a way that, in the virtual array setting in the multiple-input multiple-output (MIMO) configuration, the following two points are satisfied: a) the elements fit onto a uniformly spaced grid or pattern (preferably with a spacing of λ/2) and b) two virtual antennas are avoided at the same location (this provides only redundant information to the system). This occurs within the framework of arrays with minimal redundancy. They simultaneously minimize the blurs in the field of view and the redundancies in the information acquired by the array.

It is furthermore advantageous when a selected antenna element emits the output signal at one point in time and at least some other, in particular all, antenna elements capture the reflection signals.

An advantage results when a sequence is carried out in which a selected antenna element emits the output signal at respective points in time and at least some other, in particular all, antenna elements capture the reflection signals, wherein, at successive points in time, other antenna elements emit the output signals and at least some other, in particular all, antenna elements capture the reflection signals.

It is advantageous when the output signals have at least one output pulse, wherein the output pulse is frequency-modulated, such that a frequency of the output pulse increases, in particular from an initial frequency, preferably linearly, by a signal bandwidth (B).

According to an advantageous development of the present subject matter, it is useful when the output signals are generated with a frequency between 76 GHZ and 81 GHz.

Advantages are provided when the output signals have a plurality of output pulses. The output pulses are also referred to herein as chirps.

It is advantageous when a plurality of product values is formed by multiplication from the respective output signals and the respective reflection signals.

According to an advantageous development of the present subject matter, it is useful when the product values are filtered, in particular by means of a low-pass filter, such that filter values are formed.

It is advantageous when, during the simplification, quadratic terms are neglected and/or geometric relationships between the antenna elements are taken into account.

It is advantageous when the output signals are continuously emitted and/or the reflection signals are continuously captured. This is the operating mode of a continuous wave radar, or an FMCW radar.

An improvement results when the approximate values are shifted to a common point in time. The MIMO operating mode and coherence and stationarity of the radar unit enable the time shift to be carried out.

Advantages are provided when the approximate values \hat{x}ₘₖₙ(t) are subjected to a Fourier transform with respect to time, wherein a fast Fourier transform is preferably applied.

$${\hat{X}}_{mkn} [ {f}_{R} ] = \overline{ℱ} [ {x}_{mkn} ] ( {f}_{R} ) = {\int }_{- ∞}^{∞} {x}_{mkn} ( t ) exp ( - j 2 π {f}_{R} t ) dt = {γ}_{k} exp ( - j \frac{2 π}{λ} ( {dx}_{Rm} + {dx}_{Tn} ) sin ( {θ}_{k} ) ) {\int }_{0}^{{T}_{c}} exp ( - j 2 π ( {f}_{{R}_{k}} - {f}_{R} ) t ) dt$$

$${\hat{X}}_{mkn} [ {f}_{R} ] = {γ}_{k} exp ( - j \frac{2 π}{λ} ( {dx}_{Rm} + {dx}_{Tn} ) sin ( {θ}_{k} ) ) exp ( - j 2 π ( {f}_{{R}_{k}} - {f}_{R} ) {T}_{c} ) \frac{sin ( π ( {f}_{{R}_{k}} - {f}_{R} ) {T}_{c} )}{π ( {f}_{{R}_{k}} - {f}_{R} )}$$

It is advantageous when a maximum of \hat{K}ₘₖₙ[f_{R}] is determined for determining the distance. By the aforementioned sinc function, the maximum is where f_{R}_{ₖ}=f_{R} applies. The distance can thereby be determined.

It is advantageous when the approximate values \hat{x}ₘₖₙ(t) are subjected to a Fourier transform with respect to position, wherein a fast Fourier transform is preferably applied.

It is furthermore advantageous when the approximate values \hat{x}ₘₖₙ(t) are initially subjected to a Fourier transform with respect to time and subsequently subjected to a Fourier transform with respect to position.

It is beneficial when, after applying the Fourier transform with respect to time, the non-uniform discrete Fourier transform with respect to position is applied, with

$${\hat{\hat{X}}}_{k} [ {f}_{R} , {f}_{{Θ}_{p}} ] = {\hat{X}}_{k} [ {f}_{R} ] {\sum }_{( m = 1 , n = 1 )}^{( M , N )} exp ( j 2 {πΔ}_{mn} ( {f}_{{Θ}_{p}} - {f}_{{Θ}_{k}} ) )$$

It is also advantageous when, after determining a position, in particular direction and/or distance, and/or a speed of an object in road traffic, the associated result is output. The result of the determination of the position, the direction, the distance or the separation, and/or the speed can be output, for example, in such a way that it is displayed on a display in the vehicle. As a result, the driver of the vehicle receives feedback on the position and/or the speed of the object and can adapt their driving behavior accordingly. Additionally or alternatively, the result can advantageously also be output to a higher-level vehicle control system. This higher-level vehicle control system can then initiate, for example, a braking operation in order to avoid an accident.

The present subject matter also relates to a computer program which, when run by a computing unit, prompts the computing unit to carry out a method according to one or more method steps explained in the preceding description and/or the following description.

The present subject matter also relates to a computer-readable storage medium including a computer program, wherein the computer program, when run by means of a computing unit, prompts the computing unit to carry out a method according to one or more method steps explained in the preceding description and/or the following description.

The present subject matter also relates to a radar unit, or a radar system, which can carry out the method according to one or more method steps explained in the preceding description and/or in the following description. In particular, the radar unit, or the radar system, includes the antenna unit having a plurality of antenna elements, wherein the antenna elements are arranged in an irregular and/or sparse pattern. The radar unit, or the radar system, further includes the computing unit, which can carry out the method having at least one method step explained in the preceding description and/or in the following description. The radar unit can also include the structural features of the method claims. Additionally or alternatively, the method can also use the structural features described in the preceding description and/or of the following description.

It is advantageous when the radar unit includes a microcontroller. The microcontroller can be the computing unit. Alternatively, it is advantageous when the computing unit is integrated in the microcontroller. Using the microcontroller and/or the computing unit of the radar unit, the computations to be carried out for the method can be carried out quickly and efficiently. A computer program can be installed and/or arranged on the microcontroller, which prompts the microcontroller and/or the computing unit to determine a position, in particular direction and/or distance, and/or a speed of an object in road traffic and/or to carry out the computations necessary therefor. Additionally or alternatively, the microcontroller can be designed, for example by means of a corresponding architecture, in such a way that the microcontroller can carry out the method for determining a position, in particular direction and/or distance, and/or a speed of an object in road traffic and/or the calculations necessary therefor.

The microcontroller and/or the computing unit can be referred to as a “system on a chip”.

By means of the microcontroller and/or the computing unit, the method steps explained in the preceding description and/or the following description can therefore be carried out. These method steps include, in particular and at least, actuating the components in order to generate the output signals with the aid of the antenna unit. With the aid of the antenna unit, the reflection signals can advantageously also be captured, and the microcontroller and/or the computing unit can advantageously carry out and/or control the evaluation and/or the processing of the electrical signals based on the reflection signals. In addition, the microcontroller and/or the computing unit can output a result of the position measurement, the distance measurement, and/or the speed measurement, which is then displayed, for example, on a vehicle display as position information, distance information, and/or speed information, for example, with respect to a preceding automobile.

Additionally or alternatively, the microcontroller and/or the computing unit can also be connected to a higher-level control system of the vehicle. For example, the microcontroller and/or the computing unit can transmit the result of the position measurement, the distance measurement, and/or the speed measurement to the higher-level control system of the vehicle. The higher-level control system can, on the basis of this result, actuate, for example, a braking system and initiate a braking operation in order, for example, to avoid a rear-end collision.

The microcontroller and/or the computing unit is preferably designed and/or set up in such a way that they can manage and/or control the components of the radar unit involved in the method and/or advantageously also evaluate and/or process the signals. Additionally or alternatively, the microcontroller and/or the computing unit can output the result of the position measurement, the distance measurement, and/or the speed measurement and/or transfer these to other components in the vehicle.

The microcontroller and/or the computing unit can advantageously be a semiconductor chip and/or a microprocessor. The microcontroller and/or the computing unit can also be integrated in an “embedded chip.”

It is also advantageous when the computing unit and/or the microcontroller is connected to the antenna unit. Furthermore, the computing unit and/or the microcontroller can also be connected to the antenna elements. Thus, the computing unit and/or the microcontroller can emit the output signals and receive the reflection signals for evaluation. The computing unit and/or the microcontroller can transmit the output signals directly to the antenna unit for emission. Alternatively, the computing unit and/or the microcontroller can prompt a further element of the radar unit, for example the signal generator explained in the following description, to emit the output signals.

It is also advantageous when the radar unit includes a data store. The data store can store data needed for the method.

Additionally or alternatively, it is advantageous when the radar unit has a signal generator. The signal generator can obtain, for example, control signals from the computing unit and/or the microcontroller. The signal generator can then transmit corresponding signals to the antenna unit, which then emits the output signals.

Additionally or alternatively, it is advantageous when the radar unit has a multiplier. With the aid of the multiplier, signals can be combined and/or processed with one another in order to obtain signals which have been prepared for the method described here.

Additionally or alternatively, it is advantageous when the radar unit has a low-pass filter. With the aid of the low-pass filter, signals can be filtered.

Additionally or alternatively, it is advantageous when the radar unit has a switching unit. The switching unit can establish a connection between the signal generator and one antenna element at a time, such that the signal is conducted from the signal generator to a certain antenna element. The switching unit can switch back and forth between the antenna elements. The switching unit can be, for example, a demultiplexer.

It is also advantageous when the data store, the signal generator, the multiplier, the low-pass filter, and/or the switching unit are integrated in the computing unit and/or in the microcontroller. At least one of the elements mentioned here can be integrated in the computing unit and/or in the microcontroller. Additionally or alternatively, at least one of the elements mentioned here can also be arranged outside the computing unit and/or the microcontroller. For example, the data store can be a separate component, for example, a chip.

Additionally or alternatively, it is advantageous when the data store, the signal generator, the multiplier, the low-pass filter, and/or the switching unit are connected to the computing unit and/or to the microcontroller. For example, the data store can be a separate component from the computing unit and/or the microcontroller. A data connection and/or signal connections can be arranged between the elements mentioned here, such that the elements can communicate with one another and/or exchange data and/or signals with one another.

It is further advantageous when the computing unit, the microcontroller, the data store, the signal generator, the multiplier, the low-pass filter, and/or the switching unit are arranged on a circuit board. As a result, all elements are connected to each other. Additionally or alternatively, the antenna unit can also be coupled to the circuit board. As a result, it is also possible that the antenna unit is connected, for example, by means of a data cable and/or signal cable, to the circuit board, for example, via a connector arranged on the circuit board.

The present subject matter further relates to a vehicle having a radar unit. The radar unit can be designed according to a feature described in the preceding description and/or the following description. The radar unit can be further designed to include, in particular, the computing unit in such a way that the computing unit can carry out at least one method step explained in the preceding description and/or in the following description.

In the motor vehicle radar system, or the radar unit for a vehicle, a so-called linear frequency modulated continuous wave (LFMCW) radar is used in a multiple-input multiple-output (MIMO) configuration. Here, the signal processing generally carried out using methods of beamforming is modeled as a discrete Fourier transform (DFT) term. In the context of far-field approximation, the two methods are fundamentally equivalent.

The DFT computation for distance information conjugated to the time variable is a standard procedure in this context. If this identical process (DFT) is applied to the angular variable, however, this results in non-linearity in conjugation between the angles and angular frequencies. It is therefore important to ensure accurate sampling of the angular frequency information. For a field of view (FOV) of +/−90 degrees, a half wavelength spacing between the elements is required. This compliance with the Nyquist criterion guarantees accurate signal sampling and thus prevents the introduction of “ambiguities” during the sampling phase.

The angular resolution of the array results from the aperture of the array in conjunction with the wavelength. From a practical point of view, it is often advantageous to combine a large aperture with a sparsely distributed array. This results in violation of the Nyquist criterion, however, which affects the quality of the resulting processing. In most cases, although the DFT can still be calculated since we only operate with phasors or limited terms, the target identification can become ambiguous or even erroneous. The expression “array” is used here for the arrangement of the antenna elements, or for the antenna unit.

In the case of sparse systems or antenna units, it can be expedient to apply the formalism and the techniques of compressed sensing. This approach involves a new series of signal-processing and recovery methods that are anchored in “greedy algorithms” such as orthogonal matching pursuit (OMP). Another way that should be considered is to ensure well-controlled convergence of the DFT in handling minimum-redundancy arrays (MRA). Although this approach results in a higher geometric noise background, strategic antenna positioning can minimize the side lobe levels throughout the FOV of interest. This can be achieved by comprehensive system tuning and careful array design methods.

With the introduction of non-linearity in the angular coordinate space and the sparse, irregular positioning of the antenna elements for sampling angular frequencies, the problem can be formulated as a non-uniform DFT computation (NuDFT). The NuDFT can be calculated faster with the aid of a FFT-based method—the NuFFT algorithm. The approach can be extended to 3D imaging by including the elevation angle, the formulation and processing of which is similar to the azimuth angle. The FOV is also adapted according to the requirements in this case.

The NuFFT algorithm can require an oversampling step followed by interpolation in which the signal is aligned to the grid coordinates. This phase is the most resource-intensive part of the algorithm, in which the signal accuracy can be most adversely affected. To rationalize this step, the array can be configured in such a way that the elements of the sparse array in the virtual environment are directly aligned with the oversampling grid. This grid can be calculated during the design phase of the array. This alignment optimizes the processing when the NuFFT grid matches the uniform linear array (ULA) grid in the virtual environment. The result is that the NuFFT requires fewer additional points and the oversampling is minimized. Depending on the specific constraints and design decisions, oversampling can be increased but limited (for example, to a lambda/4 grid spacing, doubling the points used by the NuFFT algorithm).

Despite this complexity, this approach still offers considerable advantages with respect to the complexity of the Order (V*logV) algorithm and the acceleration associated with FFT-based processing.

Finally, the use of a NuDFT offers flexibility in handling real radar systems that can have slight alignment errors in the positions of the antenna elements. In this phase of signal processing, calibration information can be easily applied to the signal. In such scenarios, it is important to carefully select the interpolation function and method of the NuFFT to match the shape of the radar signal, thus ensuring precise and efficient signal processing.

The array is designed to meet requirements for NuFFT processing to enable both an efficient configuration that avoids a large oversampling grid and signal degradation. This makes it possible, after a low formulation outlay, to realize the entire signal processing under the same formalism.

A random sparse array is the worst cast setting for the application of the NuFFT algorithm. Even if the NuDFT is well defined and the arrangement is unique, the processing efficiency cannot be substantially improved by such an arrangement. To be able to apply the NuFFT algorithm, it is usually good to find a grid spacing that accommodates all or most antenna elements. It is often the case that, in the case of a random arrangement, pairs of elements rarely share a common multiple. A sufficiently dense grid is then provided so that all signals can be interpolated to some of the grid points. In this step, most of the signal is distorted and the accuracy of the signal is lost.

Among the many sensors in modern vehicles, automotive radar systems deliver high-resolution estimates of position and speed of targets. Moreover, higher angular accuracy can be achieved by using larger radar apertures that efficiently combine multiple transmitters and receivers. Sparse antenna groups, i.e. the sparsely and/or irregularly arranged antenna elements, are intended to offer such a high angular resolution and at the same time to avoid the occurrence of ambiguities which arise as a result of irregular distances between the antenna elements. In such arrays, the computational complexity for real-time applications is high. Here, considering the non-uniform, or irregular, structure of the signal under consideration, it is shown that processing methods based on non-uniform fast Fourier transforms (NuFFT) can efficiently and accurately estimate the direction of arrival (DOA) of targets.

With a multiple-input multiple-output (MIMO) configuration, large virtual arrays are formed with a smaller number of antenna elements.

The fast processing of FMCW radar signals typically includes a Fourier transform (FT) of the digitized mixed signal for each channel. For ULA arrays with a spacing of λ/2, Fourier transforms can also compute the direction of arrival (DOA) via integration over the virtual array dimension. Multi-dimensional FFT processing strategies are implemented in commercial approaches but are constrained by sampling theorems that require equidistant sampling points and pose a challenge to sparse arrays.

More recent methods of the non-uniform fast Fourier transform, or of the non-uniform, in particular fast, Fourier transform (NuFFT), make it possible to process data on irregular grids. NuFFT enables direct, efficient multi-dimensional processing of FMCW radar signals using sparse arrays. NuFFT is significant for the processing of synthetic aperture radar (SAR) data and generates high-resolution radar images by efficiently processing non-uniformly sampled data and compensating for the Doppler shift, resulting in focused images of targets.

Consider a signal emitted from an antenna element n at a point in time t so that its waveform is sₙ(t)=Acos (2π(f₀t+½St²). This waveform is subject to a linear frequency modulation (LFM) over time. The frequency starts at a value f₀ and increases linearly to f₀+B, where B is the signal bandwidth. This frequency modulation forms a pulse or even a chirp of duration T_{C} with a slope

$$S = \frac{B}{{T}_{C}} .$$

When a target k is located in front of the radar unit, or the radar system, a portion of the emitted radiation is backscattered to the system. A receiving antenna m receives an echo signal from the target k in the form sₘₖ(t)=AₖSₙ(t−τ). The received signal is the emitted signal sₙ(t) which is delayed by t and is subject to attenuation described by the amplitude coefficient Aₖ.

The emitted signal sₙ(t) and the received echo sₘₖ(t) from the target k are mixed by direct multiplication so that xₘₖₙ(t)=Sₙ(t)*sₘₖ(t). Only the low frequency, the so-called beat frequency f_{1F}, is maintained after the high-frequency component has been filtered out of xₘₖₙ(t). The resulting filtered mixed signal \tilde{k}ₘₖₙ(t)=γ_{IF}^{COS}(2πf_{IF}t+φ_{IF}) is again a periodic function. This filtered mixed signal can also be referred to as a filter value. The beat frequency f_{IF} is the difference between the transmission frequency and the echo frequency. Since the echo delay time τ=2cR is proportional to the distance R covered by the wave, f_{1F}=S*τ results. For automotive applications, the delay is short and therefore the expression for the intermediate frequency phase simplifies to φ_{1F}=2πf₀τ−πSτ²≅2πf₀τ. The amplitude term γ_{1F} takes into account the different losses of the transmitted signal intensity and the radar cross-section of the target k at this wavelength. In the following, the delay is written as™ₘₖₙ and the complex amplitude is written as γₖ since the predominant contribution is the target k. In practice, it is common to consider the two quadratures of the mixed signal separately so that xₘₖₙ(t)=γₖexp(j2πf₀τₘₖₙ)exp(j2πSτₘₖₙt).

Both terms of the signal depend mainly on the delay time τₘₖₙ of the propagation between the transmitters, the targets, and the receivers. This affects both the intermediate frequency f_{1F} and the constant phase term φ_{1F}. The time delay results from the total propagation distance with the speed c from the transmitting antenna n and the backscattering by a target k to the receiving antenna m, so that

$${τ}_{mkn} = \frac{{R}_{mkn}}{c} = \frac{{R}_{mk} + {R}_{kn}}{c}$$

applies.

The positions of the transmitter n and the receiver m are at a distance dx_{Tn} and dx_{Rm}, respectively, from a center of the array. The distance between the antenna m and n and a target k with respect to the center of the array is given by the law of cosines and has the following expressions.

Rₖₙ≅Rₖ−dx_{Tn} sin(θₖ) (1)

Rₘₖ≅Rₖ−dx_{Rm} sin(θk) (2)

The summation of both terms yields the total approximate distance between the antennas and the target k, Rₘₖₙ=Rₖₙ+Rₘₖ=2Rₖ−(dxₙ+dxₘ) sin θₖ. If the term for the time delay is simplified to dx_{RTmn}=dx_{Rm}+dx_{Tn}, the term for the time delay is obtained

$${τ}_{mkn} = \frac{{R}_{mkn}}{c} = \frac{2 {R}_{k}}{c} - \frac{{dx}_{RTmn} sin {θ}_{k}}{c} .$$

The received signal xₘₖₙ(t) has the following approximation expressions:

$${\hat{x}}_{mkn} ( t ) = {γ}_{k} exp ( - j \frac{2 π}{λ} ( {dx}_{Rm} sin ( {θ}_{k} ) ) ) exp ( - j \frac{2 π}{λ} ( {dx}_{Tn} sin ( {θ}_{k} ) ) ) exp ( j 4 π \frac{{SR}_{k}}{c} t ) \qquad ( 3 )$$

with

$$λ = \frac{c}{{f}_{0}}$$

being the wavelength of the radiation. Additional constant phase contributions independent of θ can be accommodated in the complex amplitude γₖ. Starting from (3) describing the signal expression of a single target k for a given pair n and m of transmitting and receiving antennas, respectively, we can formulate the received signals more predictively in the case of multiple antennas and targets. The present system uses time domain multiplexing (TDM) in which only one antenna is transmitting at a certain point in time and all receiving antennas listen simultaneously. This approach allows the use of the multiple-input multiple-output (MIMO) formalism.

In the TDM method, the signals are not transmitted simultaneously. However, due to the stationarity of the generated signals, they can be converted to a transmission time for processing.

The antenna position coordinates of the simulated sparse array are multiples of λ/2. According to the MIMO approach, the total signal xₘₙ(t) transmitted by an antenna n and received by an antenna m is collected and converted into a vector x(t). The signal received by an antenna m is the coherent sum of the echo contributions of all K targets in front of the antenna, such that

$${x}_{mn} ( t ) = {\sum }_{k = 1}^{K} {x}_{mkn} ( t ) .$$

At a given point in time, t,
the received signal is the vector x(t)=[x₁₁(t), x₂₁(t), . . . , x_{(M-1)N}(t), x_{MN}(t)]^{T} ∈ C^{MNx1}, where the superscript T is the transposition operator. The entire received signal includes the transmission signal and the return signal between all combinations of transmitters and receivers and is converted into the signal vector:

$$x ( t ) = {\sum }_{k = 1}^{K} {γ}_{k} A ( {θ}_{k} ) {s}_{k} ( t ) + w ( t ) \qquad ( 4 )$$

The sampling vector A(θₖ) describes the response of the array with respect to the azimuth position of the targets. A complex additive Gaussian white noise vector, such that w(t) ∈ C^{MNx1}, is added to the signal model. The temporal waveform s(t) is the FMCW mixed echo signal. For a given target k of interest, we can express the direction of departure (DoD) a_{T}(θₖ) and the direction of arrival (DOA) a_{R}(θₖ) as follows:

$${a}_{R} ( {θ}_{k} ) = {[ {e}^{- j \frac{2 π}{λ} {dx}_{R 1} sin ( {θ}_{k} )} , ... , {e}^{- j \frac{2 π}{λ} {dx}_{RM} sin ( {θ}_{k} )} ]}^{T} \qquad ( 5 )$$

$${a}_{T} ( {θ}_{k} ) = {[ {e}^{- j \frac{2 π}{λ} {dx}_{T 1} sin ( {θ}_{k} )} , ... , {e}^{- j \frac{2 π}{λ} {dx}_{TN} sin ( {θ}_{k} )} ]}^{T} \qquad ( 6 )$$

They join one another to form the sampling vector A(θₖ)=a_{R}(θₖ) a_{T}(θk)^{T} ∈ C^{MNx1}, which includes all combinations of transmitting antennas and receiving antennas and covers the entire virtual antenna area. This vector encodes the topography of the array. The complete sampling vector is then expressed as follows:

$$A ( {θ}_{k} ) = [ {e}^{- j \frac{2 π}{λ} {dx}_{RT 11} sin ( {θ}_{k} )} , {e}^{- j \frac{2 π}{λ} {dx}_{RT 12} sin ( {θ}_{k} )} , ... , \\ {e}^{- j \frac{2 π}{λ} {dx}_{RTmn} sin ( {θ}_{k} )} , ... , {e}^{- j \frac{2 π}{λ} {dx}_{RTMN} sin ( {θ}_{k} )} ] \qquad ( 7 )$$

In the following, a received signal vector x(t) is considered as described in equation (4). Since the intermediate frequency signal consists of a sum of sinusoidal terms, it is expedient to carry out the Fourier transform initially via the time variable. Numerically, this amounts to performing a fast Fourier transform (FFT) of the temporal data of each virtual array element. The azimuth spectrum with the parameter θ is then estimated for each range bin. This is generally carried out by digital beamforming (DBF). The expression is

P(θ)=A*(θ)RₓA(θ) (8)
where Rₓ is the covariance matrix of the signal x(t). Peaks from the resulting scan are sought as potential targets DOA (direction of arrival).

In the case of a uniform linear array (ULA), the DOA computation can be carried out directly by applying the FFT over the dimension of the virtual antenna positions. It is shown that, for a sparse array, an equivalent strategy for FMCW radars can be applied by using the non-uniform fast Fourier transform (NuFFT) instead of the regular FFT. Next, the identification of the sources of the received signal power (of the targets) by calculating the 2D range-azimuth spectral density will be discussed. Considering a 1D time signal y(t) with its Fourier transform Ŷ(f), the power spectral density (PSD) is the squared module of the Fourier transform, S̅_{yy}(f)=|(f)|², where t and f are conjugate Fourier variables of time and of frequency, respectively.

The PSD over the time variable is first considered with a single component xₘₖₙ(t) of x(t). We also assume that we have a target k and that the noise contributions are negligible. Starting from (3), the frequency

$${f}_{{R}_{k}} = \frac{2 {SR}_{k}}{c}$$

is defined in such a way that

$${\hat{x}}_{mkn} ( t ) = {γ}_{k} exp ( - j \frac{2 π}{λ} ( {dx}_{Rm} + {dx}_{Tn} ) sin ( {θ}_{k} ) ) exp ( j 2 π {f}_{{R}_{k}} t ) \qquad ( 9 )$$

The FT of \hat{k}ₘₖₙ(t) with the parameters f and t as conjugate Fourier variables is:

$${\hat{X}}_{mkn} [ {f}_{R} ] = \overline{ℱ} [ {x}_{mkn} ] ( {f}_{R} ) = {\int }_{- ∞}^{∞} {\hat{x}}_{mkn} ( t ) ( t ) exp ( - j 2 π {f}_{R} t ) dt = \qquad ( 10 )$$

$${γ}_{k} exp ( - j \frac{2 π}{λ} ( {dx}_{Rm} + {dx}_{Tn} ) sin ( {θ}_{k} ) ) {\int }_{0}^{{T}_{c}} exp ( - j 2 π ( {f}_{{R}_{k}} - {f}_{R} ) t ) dt \qquad ( 11 )$$

We restrict the signal to the duration of a pulse or chirp (from to =0 to Tc), i.e. the period where the signal is measured. The computation of the integral part of (11) yields:

$${\hat{X}}_{mkn} [ {f}_{R} ] = {γ}_{k} exp ( - j \frac{2 π}{λ} ( {dx}_{Rm} + {dx}_{Tn} ) sin ( {θ}_{k} ) ) exp ( - j 2 π ( {f}_{{R}_{k}} - {f}_{R} ) {T}_{c} ) \frac{sin ( π ( {f}_{{R}_{k}} - {f}_{R} ) {T}_{c} )}{π ( {f}_{{R}_{k}} - {f}_{R} )} \qquad ( 12 )$$

The range frequency f_{R} is directly proportional to the range parameter R with

$${f}_{R} = \frac{2 SR}{c} .$$

If a frequency f_{R}=f_{R}_{ₖ} is found, at which the spectral density of \hat{X}ₘₖₙ[f_{R}] is maximum, the range Rₖ of a target k is determined.

Then, the processing is extended to the azimuth direction θ. The extreme positions of the antennas in the virtual group define the aperture A=max(dx_{RTmn})−min(dx_{RTmn}). The origin of the array is situated in its center and Δ=dx_{RTmn} and

$${f}_{{θ}_{k}} = \frac{sin {θ}_{k}}{λ}$$

are defined. For the moment, Δ ∈ [−A/s,A/2] is a continuous variable.

$${\hat{X}}_{k} [ {f}_{R} ] = {γ}_{k} exp ( - j \frac{2 π}{λ} Δ {f}_{{θ}_{k}} ) exp ( - j π ( {f}_{{R}_{k}} - {f}_{R} ) {T}_{c} ) \frac{sin ( π ( {f}_{{R}_{k}} - {f}_{R} ) {T}_{c} )}{π ( {f}_{{R}_{k}} - {f}_{R} )} \qquad ( 13 )$$

The adjunct Fourier transform is applied to equation (13) with Δ and f_{θ} as conjugate parameters.

$${\hat{X}}_{k} [ {f}_{R} , {f}_{Θ} ] = {\int }_{- ∞}^{∞} \hat{X} [ {f}_{R} ] exp ( j 2 πΔ {f}_{θ} ) d Δ = {γ}_{k} [ exp ( - j π ( {f}_{{R}_{k}} - {f}_{R} ) {T}_{c} ) \frac{sin ( π ( {f}_{{R}_{k}} - {f}_{R} ) {T}_{c} )}{π ( {f}_{{R}_{k}} - {f}_{R} )} ] * \qquad ( 14 )$$

$${\int }_{- A / 2}^{A / 2} exp ( j 2 πΔ {f}_{{θ}_{k}} ) exp ( j 2 πΔ {f}_{θ} ) d Δ \qquad ( 15 )$$

Calculating the integral as before and considering all K targets yields:

$${X}^{\hat{\hat{}}} [ {f}_{R} , {f}_{Θ} ] = {\sum }_{k = 1}^{K} {γ}_{k} exp ( - j 2 π ( {f}_{{R}_{k}} - {f}_{R} ) {T}_{c} ) \frac{sin ( π ( {f}_{Θ} - {f}_{{Θ}_{k}} ) A )}{π ( {f}_{Θ} - {f}_{{Θ}_{k}} )} \frac{sin ( π ( {f}_{R} - {f}_{{R}_{k}} ) {T}_{c} )}{π ( {f}_{R} - {f}_{{R}_{k}} )} \qquad ( 16 )$$

In practice, the signal points of (16) are plotted for certain, discrete values. In particular, the signal is sampled at uniform time intervals Δt by a digitizer, such that a certain recorded point in time is given by t=t0+lΔΔt, where l is the sample count and t0 is the start time. This makes it possible to calculate the previous Fourier integrals by means of discrete Fourier transforms (DFT). Knowing f_{R}=f_{R}_{ₖ} directly indicates the range of the detected target with

$${R}_{k} = {f}_{{R}_{k}} \frac{c}{2 S} .$$

According to the theory of regular sampling, the radar system has a maximum detection range of

$$\frac{c}{4 S Δ t} ≃ 250$$

and a range resolution of

$$\frac{c}{2 S} ≃ 15 cm$$

at numerical values such as Δt=10 ns, Tc=33 μs and B=1 GHz.

Similar to the range, the DOA of a target is determined by determining f_{θ}=f_{θ}_{ₖ}, and it becomes possible to determine the angle parameter associated with the various targets. The radiation over the aperture A is sampled by the various virtual antennas. To obtain high-resolution DOA estimates, large arrays are required. It is attractive to sample the signal using strategically positioned antennas. The DOA calculation requires that the estimate of a target at a certain angle be unique over the entire field of view. This can be optimized by minimizing the side lobe levels (SLL) of a sparse array with irregular positioning of the antennas.

An array with minimum redundancy is created. It has 59 degrees of freedom and a redundancy value of 1.08. From the calculation of the array factor, it is clear that the detection of a target in front of the radar is unique, although the SLL is higher than with a ULA having the same aperture size.

The DOA of targets is determined directly by beamforming using equation (8). This DOA estimating method has a quadratic complexity with the number of the evaluated azimuth angle. In analogy to the ULA case, it is also possible to calculate the azimuth spectral density using equation (14) with the aid of non-uniform discrete Fourier transform methods. For a given sparse array having antenna positions dx_{RTmn}, NuFFT efficiently calculates p Fourier coefficients f_{θ}_{ₚ} that are distributed within [−1/λ, 1/λ] and provided by the following non-uniform DFT

$${{X}^{\hat{\hat{}}}}_{k} [ {f}_{R} , {f}_{{Θ}_{p}} ] = {\hat{X}}_{k} [ {f}_{R} ] {\sum }_{( m = 1 , n = 1 )}^{( M , N )} exp ( j 2 {πΔ}_{mn} ( {f}_{{Θ}_{p}} - {f}_{{Θ}_{k}} ) ) \qquad ( 17 )$$

Amn can correspond to the positions of the antenna elements dx_{RTmn}. The NuFFT algorithm uses the fast Fourier transform (FFT) in its kernel calculation by using an oversampling factor and an interpolation step. The oversampling factor ensures that the non-uniform sample values are correctly represented in the frequency range, whereas the interpolation step bridges the gap between the non-uniformly distributed points and the oversampled grid required for applying a regular FFT. Thus, the computational complexity of the NuFFT order is (V*logV), where V is the number of Fourier coefficients after oversampling. This complexity is comparable to the standard FFT and makes the NuFFT a computationally efficient method.

To illustrate the foregoing discussion, signal data are generated using equation (4) with the exact time delays, whereas processing is carried out using the approximation expressions of equation (2). The range FFT is first applied to the time traces, followed by DBF or azimuth NuFFT on the range regions over the virtual array channels.

The NuFFT is numerically calculated with a specific library. For the sparse array, the results of the non-uniform Fourier processing are similar to those achieved with DBF. Individual targets are well resolved, as are the two extended obstacles. This illustrates the applicability of the non-uniform Fourier transform-based processing to the angular resolution of sparse FMCW radar systems. Also, speed estimation could also benefit from the use of non-uniform sampling, as the sampling is not continuous with TDM-MIMO. We assume that the direct use of processing methods that take into account irregularities in the sampling parameters, whether spatially or temporally sparse, is extended to other dimensions to efficiently detect range, speed (Doppler), azimuth, and elevation by performing a 4D NuFFT.

Exemplary values are f₀=70 through 80 GHZ, B=1 through 4 GHZ, Tc=5 through 75 μs and/or Δt=2 bis 20 ns. Advantageous values are f₀=77 GHZ, B=1 GHZ, T_{c}=33 μs and/or Δt=10 ns.

With the advent of larger arrays consisting of sparsely distributed antennas, radar systems are aiming to simultaneously provide high-resolution range, distance, and angle estimates for potential targets ahead of a vehicle. This results in large amounts of data having to be processed to achieve target capture in real time. Efficient processing methods are required for this purpose. This work demonstrates that known azimuth FFT-based processing methods can be extended to a sparsely and non-uniformly populated field for an FMCW radar system. To this end, the angle FFT is replaced by an angle NuFFT that takes into account the dispersion and irregularity of the array and of the signal structure. Both the range and azimuth processing are then calculated with the same complexity as the regular FFT. In the automotive field, the approach presented could be extended to also improve the Doppler effect processing in MIMO radars.

Starting from the MIMO signal model in matrix form,

$$x ( t ) = {\sum }_{k = 1}^{K} {γ}_{k} A ( {θ}_{k} ) {s}_{k} ( t ) + w ( t ) , \qquad ( 18 )$$

the covariance matrix Rₓ of the signal vector can be easily calculated. It will be used later for a variety of operations. With this approach, the amount of data can be reduced by computing out the time dependency.

The covariance matrix is:

Rₓ=E[x(t)x^{H}(t)] (19)

Rₓ=AE[s(t)s^{H}(t)]A^{H}+σ²I₀ (20)
where σ² of the noise power and I₀ of the identification matrix, or the identity matrix. From this we can then calculate the pseudo-periodogram as estimated by the digital beamforming approach having an intensity peak when θ=θₖ,

P(θ)=A*(θ)RₓA(θ) (21)

This method is more general, but slower than the approach based on Fourier transforms. In beamforming, a good delay is sought (scanned for) which causes a peak. The approach is closer to a cross-correlation, whereas the FFT-based spectral density is an auto-correlation of the signal, which can furthermore be evaluated numerically efficiently.

In the following section, using the expression about the NuDFT, we briefly review the usual steps carried out in applying the NuFFT. Since this is a new numerical approximation method, there are many variants. The usual approach is to regulate the signal to match the conditions to be used with the regular FFT algorithm.

The signal model is transcribed using notations as follows:

xₘₖₙ(t)=γₖ exp(−j2πf_{θ}Δₘₙ)exp(j2πf_{R}_{ₖ}t) (22)

This yields the following NuDFT formulation:

$${{X}^{\hat{\hat{}}}}_{k} [ {f}_{R} , {f}_{{Θ}_{p}} ] = {\hat{X}}_{k} [ {f}_{R} ] {\sum }_{( m = 1 , n = 1 )}^{( M , N )} exp ( j 2 {πΔ}_{mn} ( {f}_{{Θ}_{p}} - {f}_{{Θ}_{k}} ) ) \qquad ( 23 )$$

Given the non-uniform DFT (NuDFT=non-uniform discrete Fourier transform) term according to equation (23), to simplify the term and without loss of generality to the present problem, the range contributions are not taken into account and the signal of interest (for a single target k and a virtual antenna v) can be formulated as γᵥ(t)=exp(−j2πf_{θ}_{ₖ}dxᵥ). This yields the following NuDFT:

$${X}_{k} [ {f}_{p} ] {\sum }_{v = 1}^{V} exp ( j 2 π {dx}_{v} ( {f}_{p} - {f}_{k} ) ) \qquad ( 24 )$$

Here, X[fₚ] is the DFT coefficient at the frequency point fₚ, V is the number of virtual antennas, dxᵥ is the position of the v^{th} antenna in the virtual antenna grid, fₖ is the angular frequency of the k^{th} target, and fₚ is the frequency point in the DFT.

The number of virtual antennas V is obtained from the product V=N×M of the number of transmitting antennas and receiving antennas. To calculate the NuFFT along the array aperture direction, it is important that it be sampled along the 1D aperture. As described by the signal model according to equation (3), the phase effect of the position of the transmitting antenna and receiving antenna can be combined in the far field in a single variable dxᵥ. This is advantageous because it can reduce the calculation along the aperture (to obtain the DOA) to a single variable instead of the two positions of the transmitter and receiver.

For a MIMO system and in the far field, the virtual array, or antenna array or antenna grid, is formed by considering all possible pairs of transmitting antennas and receiving antennas. When there are M transmitting antennas and N receiving antennas, a virtual array of M×N elements results. Since the information of all antenna combinations is used, this larger virtual array, or antenna array or antenna grid, can provide better resolution and greater coverage compared to a physical array with the same number of elements.

In the signal model according to equation (3), this amounts to the factorization of the angle contributions

$$- j \frac{2 π}{λ} ( {dx}_{Rm} sin ( {θ}_{k} ) ) and - j \frac{2 π}{λ} ( {dx}_{Tn} sin ( {θ}_{k} ) )$$

with factor dx_{RTmn}=dx_{Rm}+dx_{Tn}, the virtual array coordinate, which is parameterized by the number of transmitters n and receivers m. The signal model is then

$${\hat{x}}_{mkn} ( t ) = {γ}_{k} exp ( - j \frac{2 π}{λ} ( {dx}_{RTmn} sin ( {θ}_{k} ) ) ) exp ( j 4 π \frac{{SR}_{k}}{c} t )$$

using the virtual field coordinate d_{xRTmn}. This allows extension of regular radar processing methods for MIMO arrays.

For the NuFFT algorithm, the following elements can be provided as inputs (in a 1D formulation):
non-uniform data points yᵥ, for v=1, 2, . . . , V.
corresponding non-uniform positions dxᵥ, for v=1, 2, . . . , V.
desired Fourier frequencies fₚ₍ₖ₎, für k=1, 2, . . . , K.

A first step of the algorithm is rasterization. This step is essentially an interpolation process. The gridded data Yₚ serves as an approximation of the original signal at the newly defined grid points. We map our non-uniform data to a uniform grid. For each non-uniform data point yᵥ at the location dxᵥ, we calculate its contribution to the adjacent grid points. The gridded data Yₚ is calculated as follows:

$${Y}_{p} = {\sum }_{v = 1}^{V} {y}_{v} exp ( - j 2 π {f}_{p ( k )} {dx}_{v} ) ϕ ( {u}_{{v}_{p}} ) \qquad ( 25 )$$

where

$${u}_{{v}_{p}} = {dx}_{v} - \frac{p}{R}$$

is the offset function and R is the oversampling factor. The grid kernel φ(u) using a Kaiser-Bessel function is given by:

$$ϕ ( u ) = \{ \begin{matrix}\frac{1}{W} & {I}_{0} [ \frac{πW}{2} \sqrt{1 - {( \frac{2 u}{W} )}^{2}} \\ 0 & otherwise\end{matrix} for \vert u \vert < \frac{W}{2} \qquad ( 26 )$$

where W is the kernel width and I₀ is the modified Bessel function of the first type.

The Kaiser-Bessel function is generally used as a grid kernel due to its advantageous properties in preserving signal integrity during redistribution.

Next, and because the gridded data is uniformly distributed, we perform a standard fast Fourier transform (FFT) on the gridded data. We map the grid index p to the Fourier frequency index k by

$${f}_{p ( k )} = \frac{p}{R} :$$

$${\hat{Y}}_{p ( k )} = FFT \{ {Y}_{p} \} \qquad ( 27 )$$

Finally, the convolution can be corrected with the Fourier transform of the grating kernel.

In this step, since the grid function convolved with the signal during the gridding process, the data subjected to a Fourier transform is deconvolved by being divided by the grid function, G(fₚ₍ₖ₎, that has been subjected to a Fourier transform. We carry out a deconvolution by dividing the FFT result by the gridding kernel G(fₚ₍ₖ₎) that has been subjected to a Fourier transform:

$${X}_{k} = \frac{{\hat{Y}}_{p ( k )}}{G ( {f}_{p ( k )} )} \qquad ( 28 )$$

where G(fₚ₍ₖ₎) is the grid kernel that has been subjected to a Fourier transform and is given by the following:

$$G ( {f}_{p ( k )} ) = \frac{1}{\sqrt{1 - {( \frac{2 {f}_{p ( k )}}{W} )}^{2}}} \qquad ( 29 )$$

for |fₚ₍ₖ₎|≤W/2 and otherwise 0.

The corrected Fourier transform xₖ is a numerical estimate of the original signal data in the desired Fourier frequencies fₚ₍ₖ₎, for k=1, 2, . . . , K.

A short list of the various symbols and their meaning:
yᵥ: non-uniform data points.
dxᵥ: non-uniform locations corresponding to yv.
fₚ₍ₖ₎: desired Fourier frequencies.
Yₚ: gridded data.
Ŷₚ₍ₖ₎: FFT of the gridded data.
Xₖ: corrected Fourier transform, the final result.
uᵥ_{ₚ}: offset function.
R: oversampling factor.
φ(u): gridding kernel function.
G(fₚ₍ₖ₎): Fourier transform of the grid kernel.
W: half the width of the gridding kernel in the frequency range.

A linear frequency modulation for so-called LFMCW systems (LFMCW=linear frequency modulated continuous wave) is explained below. This is a linear modulation of the frequency and a continuous wave operating mode. The signal is a sequence of frequency chirps. The linear frequency modulation (chirp) has the following form: f(t)=f₀+St, where f₀ is the carrier frequency, S=B/T_{c} is the modulation rate, and t is the time variable.

The phase of the signal of the transmitting antennas n, or of a transmitting antenna element n, is the time integral of the frequency

$${ϕ}_{n} ( t ) = {\int }_{0}^{t} f ( τ ) d τ = {\int }_{0}^{t} ( {f}_{0} + S τ ) d τ \qquad ( 30 )$$

$${ϕ}_{n} ( t ) = {f}_{0} t + \frac{1}{2} {St}^{2}$$

It follows that the emitted signal and the received signal are as follows:

xₙ(t)=A cos(2π(fₒt+½St²)

xₘₖ(t)=A cos(2πfₒ(t−τₘₖ)+½S(t−τmk)²) (31)

The received signal xₘₖ(t) is delayed by the flight time τₘₖ between the individual targets and the receiver. The index n stands for a transmitting antenna element, namely the n^{th} transmitting antenna element. The index m stands for a receiving antenna element, namely the m^{th} receiving antenna element. The index k stands for an object.

The received signal is multiplied directly by the transmitted signal to mix or dechirp the obtained signal. The result is a mixed signal

$${x}_{m i x}^{( m k n )} ( t ) = {x}_{n} ( t ) {x}_{m k} ( t )$$

with two contributions at high and low frequencies. The high-frequency contribution is then filtered out, such that only the low beat frequency of the signal, i.e. the frequency difference between the two signals, is retained.

$${x}_{m i x}^{( m k n )} ( t ) = {x}_{n} ( t ) {x}_{m k} ( t ) \qquad ( 32 )$$

$${x}_{m i x}^{( m k n )} ( t ) \approx \frac{1}{2} cos ( 2 π ( {f}_{0} {τ}_{m k} - S {τ}_{m k} t + \frac{1}{2} S {τ}_{m k}^{2} ) ) \qquad ( 33 )$$

The quadratic term in τₘₖ can be neglected because the delay τₘₖ in the far field of the radar system makes no substantial contribution or because τₘₖ is short. Thus,

$${x}_{m i x}^{( m k n )} ( t ) \approx \frac{1}{2} cos ( 2 π ( {f}_{0} {τ}_{m k} - S {τ}_{m k} t ) \qquad ( 34 )$$

In this section, 3D imaging with the radar system will be described. In addition to the range and azimuth, the elevation information is considered. The elevation is analogous to the azimuth and functions similarly in a sparse array. The two dimensions are orthogonal and therefore terms and contributions have similar terms (with respectively own variables). The field of view with respect to the elevation is also generally much smaller.

The 3D spectral density taking into account the elevation at the angular frequency f_{φ} and in conjunction with the contributions of targets in f_{Φ}_{ₖ} and across an aperture B is:

$$\hat{\hat{X}} [ {f}_{R} , {f}_{Θ} , {f}_{Φ} ] = {\sum }_{k = 1}^{K} {γ}_{k} exp ( - j π ( {f}_{{R}_{k}} - {f}_{R} ) {T}_{c} ) \frac{sin ( π ( {f}_{R} - {f}_{{R}_{k}} ) {T}_{c} )}{π ( {f}_{R} - {f}_{{R}_{k}} )} \frac{sin ( π ( {f}_{Θ} - {f}_{{Θ}_{k}} ) A )}{π ( {f}_{Θ} - {f}_{{Θ}_{k}} )} \frac{sin ( π ( {f}_{Φ} - {f}_{{Φ}_{k}} ) B )}{π ( {f}_{Φ} - {f}_{{Φ}_{k}} )} \qquad ( 35 )$$

We indicate that for a full 3D description of the present signal DFT, it can be necessary to introduce the two electrical angles in accordance with the usual spherical coordinates and define the two independent frequencies f_{Θ} and f_{Φ}, as well as the terms given below, to obtain the representation with a 2D sparse antenna array.

As a rule, a signal model can be assumed which includes the range Rₖ, the azimuth θₖ, and the elevation φₖ with respect to the target k and which is as follows:

$${\hat{x}}_{m k n} ( t ) = {γ}_{k} exp ( - j \frac{2 π}{λ} ( {dx}_{R m} + {dx}_{T n} ) sin ( {θ}_{k} ) cos ( {ϕ}_{k} ) ) ) exp ( - j \frac{2 π}{λ} ( {dy}_{R m} + {dy}_{T n} ) sin ( {ϕ}_{k} ) ) ) exp ( j 4 π \frac{{SR}_{k}}{c} t ) ( 3 bis )$$

The virtual array, or antenna grid, is extended in 2D in the plane perpendicular to the propagation of the radiation. Here, the coordinates of the virtual group can be indexed by two variables, one for the horizontal coordinates of the antenna elements dx_{RTmn}=dx_{Rm}+dx_{Tn} and the other for the vertical coordinates dy_{RTmn}=dy_{Rm}+dy_{Tn}. Then we introduce a variable change for the angular coordinates so that they become independent for the two orthogonal directions. We define pₖ=sin(θₖ)cos(φₖ) and qₖ=sin (φₖ). With this change, the signal model (with dx_{RTmn}=dx und dy_{RTmn}=dy) is:

$${\hat{x}}_{m k n} ( t ) = {γ}_{k} exp ( - j \frac{2 π}{λ} dx {p}_{k} ) exp ( - j \frac{2 π}{λ} dy {q}_{k} ) exp ( j 4 π \frac{{SR}_{k}}{c} t ) ( 3 ter )$$

With this equation, the variables associated with both angular directions are separated, and the same scheme as described above using the NuFFT is applicable to the conjugate variables dx and p_k and the conjugate variables dy and qₖ.

The inverse transform to restore ex and ok is also performed directly from the knowledge of pₖ and qₖ. We have φₖ=arcsin (qₖ)

$${θ}_{k} = arcsin ( \frac{{p}_{k}}{\sqrt{1 - {q}_{k}^{2}}} ) .$$

This allows the use of sparse 2D arrays with the NuFFT processing described above for the 1D case and the performance of 3D static case imaging and 4D dynamic case imaging with range, Doppler speed, azimuth, and elevation.

Finally, the processing presented herein is fully compatible with sparse array 4D imaging. The time component of the signal model can be supplemented by the contribution of the Doppler speed phase. The signal model then becomes x̅ₘₖₙ(t)=x̅ₘₖₙ^{(t)ej2πΔf t}, where

$$Δ f = \frac{2 v}{λ}$$

is the frequency shift resulting from the radial speed. In most radar systems, the signal is sampled by the digitizer at regular time intervals. The range and the Doppler speed both depend on the time variable t and can be processed with a regular common 2D FFT for the fast (range) contribution and the slow (Doppler speed) contribution of the signal. We can also remember that the regular FFT is a boundary case of the NuFFT with regular sampling spacings. This allows the radar system to operate even in irregular time samplings by using a 2D NuFFT for the time variable.

Finally, the processing formalism according to the present subject matter can include 4D processing (azimuth, elevation, range, speed) with a sparse array and potentially irregular sampling values in the time range in a single formalism using a 4D NuFFt. In the usual case of regular sampling of the signal by the detection system, the NuFFT is reduced to the regular FFT.

### BRIEF DESCRIPTION OF THE FIGURES

Further advantages of the invention are described in the following exemplary embodiments. Wherein:

FIG. 1 shows a schematic view of a radar unit for determining a position and/or a speed of an object,

FIG. 2 shows a detail from the signal generation, the signal capture and evaluation, and

FIG. 3 shows a frequency-time diagram of the output signal and the reflection signal.

### DETAILED DESCRIPTION

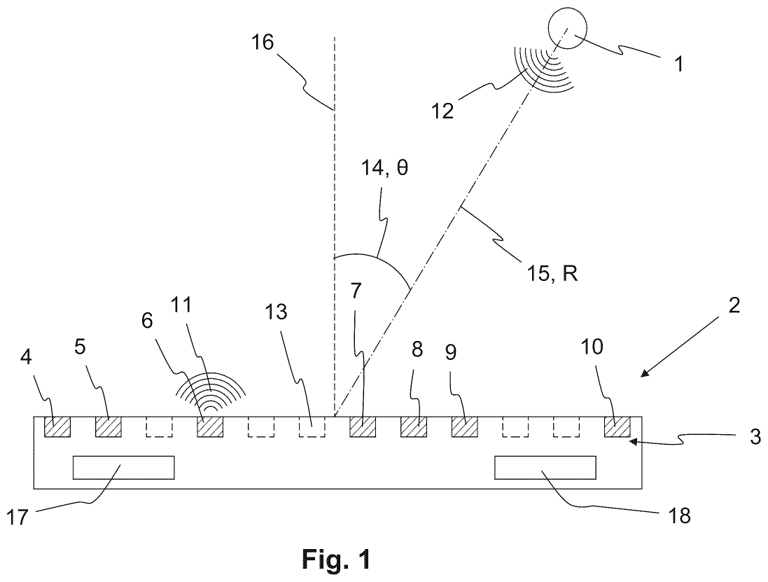

FIG. 1 shows a schematic view of a radar unit 2 for determining a position and/or a speed of an object 1. The object 1 is, for example, a vehicle, a pedestrian, a bicycle, a tree, or a column. The object 1 can be detected with the aid of the radar unit 2. This is used for driver-assistance systems in order to make road traffic more safe. In particular, accidents can be avoided or prevented.

The radar unit 2 is furthermore arranged on and/or in a vehicle. The radar unit 2, also referred to as a radar system, includes a computing unit 17 and/or a data store 18. The computing unit 17 can carry out the method described herein, and data required for this purpose, such as a program and/or the positions of antenna elements 4-10, can be stored in the data store 18.

The radar unit 2 further includes an antenna unit 3 having a plurality of antenna elements 4-10. The antenna elements 4-10 are arranged in an irregular and/or sparse pattern. The pattern is not random, however. Rather, the antenna elements 4-10 are arranged in such a way that the signals captured therewith can be evaluated using the method described herein, in particular by means of non-uniform fast Fourier transform.

By means of the antenna elements 4-10 arranged in the irregular pattern, output signals 11 can be emitted. These output signals 11 hit the object 1 and are reflected by the same. As reflection signals 12, they return to the radar unit 2 and are captured by the antenna elements 4-10 arranged in the irregular pattern. The antenna elements 4-10 can thus be operated as transmitting antennas and receiving antennas.

According to the antenna unit 3 shown in FIG. 1, the unit 3 also includes unoccupied antenna positions. In an antenna unit 3 having antenna elements 4-10 in a regular pattern, all antenna positions are occupied. These can have a spacing of λ/2, where λ is the wavelength of the signals 11, 12. Such antenna units 3 are also referred to as ULA, which stands for uniform linear arrays.

In the method described herein, in particular a computer-implemented method, however, an antenna unit 3 is used, wherein the antenna elements 4-10 are arranged in an irregular pattern. The antenna elements 4-10 are arranged here in such a way that, in the case of a virtual arrangement of the antenna elements 4-10, in particular in a multiple-input multiple-output (MIMO) operation, ambiguities in the detection of the object 1 are prevented. In some scenarios, two objects 1 can be detected in a random pattern after the evaluation, even though only one object 1 is present. In the method described herein, so-called sparse (antenna) arrays are used.

Furthermore, an unoccupied antenna position 13 is shown in FIG. 1. Due to the unoccupied antenna positions 13 (the antenna unit 2 has a plurality of unoccupied antenna positions 13), an irregular pattern of antenna elements is formed. Additionally or alternatively, the antenna elements 4-10 are hereby sparsely arranged. As a result, fewer antenna elements 4-10 are required in comparison to uniform linear arrays (ULA).

To determine the position and/or the speed of the object 1, a non-uniform Fourier transform, in particular a non-uniform discrete Fourier transform and/or a non-uniform fast Fourier transform algorithm, is carried out. This method can evaluate the signals, in particular the captured reflection signals 12, which are captured by the antenna elements 4-10 arranged in the irregular pattern.

An angle 14 can be determined as the position of the object 1, wherein the angle is also designated as θ in the preceding description. The angle 14, or θ, is measured here with respect to the center line 16 of the radar unit 2 and/or of the antenna unit 3. If the radar unit 2 is arranged, for example, in a front bumper on an automobile, the object 1 is located to the right in front of the automobile.

Additionally or alternatively, a distance 15 from the object 1 can also be determined using the method described herein. The distance 15 is also denoted by R in the present description. The distance 15, or R, is measured between the object 1 and the intersection point between center line 16 and radar unit 2 and/or antenna unit 3.

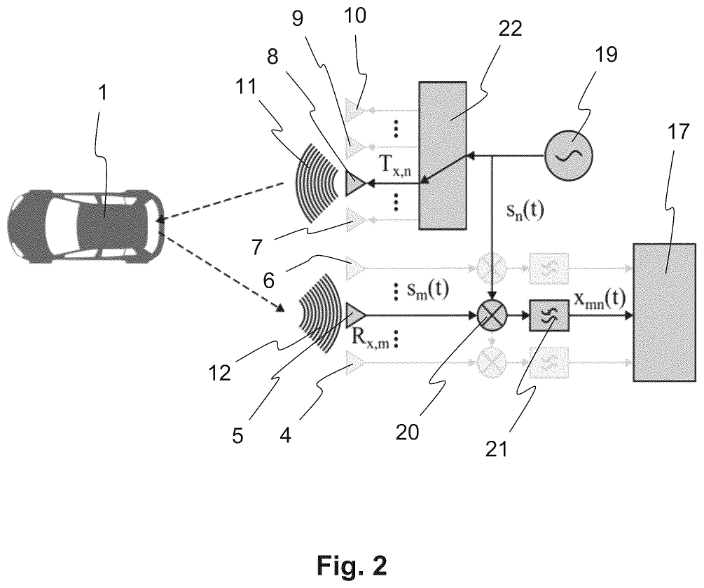

FIG. 2 shows a detail with respect to the transmission, the reception of the signals, and the evaluation of the signals, in particular of the reflection signals. The output signals 11 are generated with the aid of a signal generator 19, which are emitted from the antenna elements 4-10. The signal generator 19 does not generate the output signals 11 directly, but rather generates electrical signals corresponding thereto, which electrical signals are converted by the antenna elements 4-10 into the output signals 11. The signal generator 19 can be connected to the computing unit 17 via a connection not shown here. Consequently, the computing unit 17 can transmit control commands to the signal generator, such that it can prompt the antenna elements 4-10 to emit the output signals 11.

Furthermore, a switching unit 22 is shown in FIG. 2, which transmits the signals coming from the signal generator 19 to the corresponding antenna elements 4-10. The switching unit 22 can establish a connection to one antenna element 4-10 at a time, such that the signal from the signal generator 19 can be conducted to the corresponding antenna element 4-10. The switching unit 22 can switch back and forth between the antenna elements 4-10. The switching unit 22 can be, for example, a demultiplexer.

At the object 1, which is an automobile in this case, the signals 11 are reflected and return as reflection signals 12 and are captured again by the antenna elements 4-10. As electrical signals, the output signals 11 and the reflection signals 12 have the forms Sₙ(t) and Sₘ(t) as shown in FIG. 2. The antenna elements 4-10 convert electrical signals into the output signals 11. In addition, the antenna elements 4-10 convert the reflection signals 12 into corresponding electrical signals. These two signals are supplied to a multiplier 20 which multiplies the two signals Sₙ(t) and Sₘ(t) representing the output signals 11 and the reflection signals 12. The index n stands for an output signal 11 and the index m stands for a reflection signal 12.

The signals Sₙ(t)*Sₘ(t)=Xₘₙ(t) multiplied by one another are filtered with the aid of a low-pass filter 21. The computing unit 17 then follows, which carries out the further method. Alternatively, the multiplier 20 and/or the low-pass filter 21 and/or the signal generator 19 can also be integrated into the computing unit 17. In addition, there can also be a connection, for example for data exchange, between the computing unit 17 and the multiplier 20, the low-pass filter 21, the signal generator 19, the switching unit 22, and/or the data store 18, which is not shown here.

The computing unit 17 can furthermore be a microcontroller or a microprocessor. The computing unit 17 can also be integrated in the microcontroller or in the microprocessor. The elements shown in FIG. 2 can be connected to each other by means of data connections and/or signal connections. Additionally or alternatively, at least some of the elements shown in FIG. 2 can be integrated in the computing unit 17 and/or in the microcontroller. At least some of the elements shown in FIG. 2 can also be arranged outside the computing unit 17 and/or the microcontroller. For example, the data store 18 can be arranged outside and/or designed as a separate chip.

Furthermore, the elements mentioned and shown in FIG. 2 can be arranged on a circuit board. The antenna unit 3 and/or the antenna elements 4-10 can also be arranged on the circuit board. Alternatively, the antenna unit 3 and/or the antenna elements 4-10 can also be connected to the circuit board via a data connection and/or signal connection, for example, in the form of a cable.

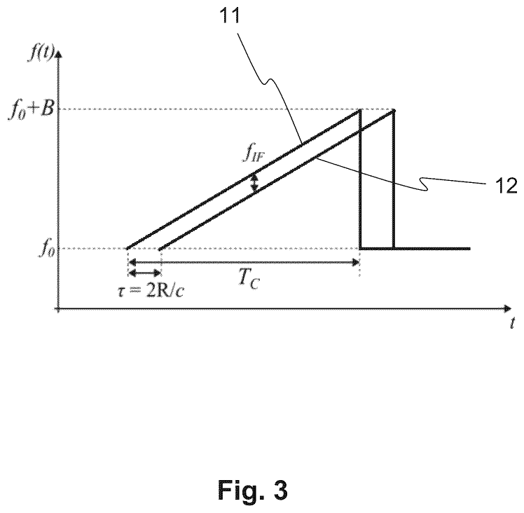

FIG. 3 shows a frequency-time diagram of the output signal 11 and the reflection signal 12. In the diagram shown in FIG. 3, the output signal 11 and the reflection signal 12 are shown as a pulse, wherein this pulse is not to be understood as a temporal pulse. The pulse is defined as increasing in frequency from fₒ to f₀+B, as shown in FIG. 3. Once the maximum frequency f₀+B has been reached, the output signal 11 can begin again at f₀. Since the reflection signal 12 is based on the output signal 11, the reflection signal 12 substantially has the same shape. The output signal 11 and the reflection signal 12 shown in FIG. 3 are also referred to as a chirp, as is also partially made in the preceding description. The output signal 11 and the reflection signal 12 have a time duration Tc here. Here, T denotes the time until the reflection signal 12 is captured again after emission of the output signal 11. A connection to the distance 15, or R, is established via

$$τ = \frac{2 R}{c}$$

with c representing the speed of light.

### LIST OF REFERENCE CHARACTERS

1 object
2 radar unit
3 antenna unit
4 first antenna element
5 second antenna element
6 third antenna element
7 fourth antenna element
8 fifth antenna element
9 sixth antenna element
10 seventh antenna element
11 output signals
12 reflection signal
13 unoccupied antenna position
14, θ angle
15, R distance
16 center line
17 computing unit
18 data store
19 signal generator
20 multiplier
21 low-pass filter
22 switching unit

1-37. (canceled)

38. A computer-implemented method for determining a position and/or a speed of an object in road traffic using a radar unit in a vehicle, wherein the radar unit includes an antenna unit having a plurality of antenna elements, wherein the plurality of antenna elements are arranged in an irregular pattern,
emitting output signals with the aid of the irregularly arranged antenna elements;
capturing reflection signals with the aid of the irregularly arranged antenna elements; and
evaluating the captured reflection signals using a non-uniform Fourier transform to determine the position and/or the speed of the object.

39. The method of claim 38, wherein the plurality of antenna elements are arranged on grid points of a two-dimensional grid, wherein some grid points of the two-dimensional grid are unoccupied and/or wherein the plurality of antenna elements are arranged in a sparsely occupied grid.

40. The method of claim 38, further comprising storing positions of the plurality of antenna elements in a data store and retrieving the positions of the plurality of antenna elements from the data store to carry out the non-uniform Fourier transform.

41. The method of claim 38, wherein the position of the object comprises an angle of the object relative to the antenna unit and wherein evaluating the captured reflection signals using a non-uniform Fourier transform to determine the position and/or the speed of the object comprises evaluating the captured reflection signals using a non-uniform Fourier transform to determine the angle of the object.

42. The method of claim 38, wherein the position of the object comprises a direction of the object relative to the antenna unit and/or a distance of the object from to the antenna unit and wherein evaluating the captured reflection signals using a non-uniform Fourier transform to determine the position and/or the speed of the object comprises evaluating the captured reflection signals using a non-uniform Fourier transform to determine the direction of the object relative to the antenna unit and/or the distance of the object from the antenna unit

43. The method of claim 38, wherein emitting the output signals comprises emitting the output signals from a selected antenna element of the plurality of antenna elements at one point in time and wherein capturing the reflection signals comprises capturing the reflection signals with at least some other antenna elements of the plurality of antenna elements.

44. The method of claim 38, wherein emitting the output signals and capturing the reflection signals comprise carrying out a sequence in which a selected antenna element of the plurality of antenna elements emits output signals at respective points in time and at least some other antenna elements of the plurality of antenna elements capture the reflection signals, wherein, at successive points in time, other antenna elements of the plurality of antenna elements emit the output signals and at least some other antenna elements of the plurality of antenna elements capture the reflection signals.

45. The method of claim 38, further comprising forming a plurality of product values by multiplication of respective output signals and respective reflection signals.

46. The method of claim 45, further comprising filtering the product values using a low-pass filter to form filter values.

47. The method of claim 46, further comprising simplifying the filter values to form approximate values.

48. The method of claim 47, wherein simplifying the filter values comprises neglecting quadratic terms in order to simplify φ_{IF} of the filter values, and/or taking into account geometric relationships between the plurality of antenna elements.

49. The method of claim 47, further comprising shifting the approximate values to a common point in time.

50. The method of claim 49, further comprising subjecting the approximate values to a fast Fourier transform with respect to time.

51. The method of claim 50, wherein the position of the object comprises a distance of the object from the antenna unit, further comprising determining a maximum of the transformed approximate values to determine the distance to the object.

52. The method of claim 47, further comprising subjecting the approximate values to a fast Fourier transform with respect to position or further comprising subjecting the approximate values to a fast Fourier transform with respect to time and subsequently subjecting the approximate values to a fast Fourier transform with respect to position.

53. The method of 52, wherein after applying the fast Fourier transform with respect to time, a non-uniform discrete Fourier transform with respect to position is applied, with
$${\hat{\hat{X}}}_{k} [ {f}_{R} , {f}_{{Θ}_{p}} ] = {\hat{X}}_{k} [ {f}_{R} ] {\sum }_{( m = 1 , n = 1 )}^{( M , N )} exp ( j 2 π {Δ}_{m n} ( {f}_{{Θ}_{p}} - {f}_{{Θ}_{k}} ) ) .$$

54. A radar unit for determining a position and/or a speed of an object in road traffic, the radar unit comprising:
an antenna unit having a plurality of antenna elements, the plurality of antenna elements being arranged in an irregular pattern, the plurality of antenna elements being configured to emit output signals and capture reflections signals; and
a computing unit configured to carry out the method of claim 38.

55. The radar unit of claim 54, wherein the radar unit includes a microcontroller, wherein the microcontroller is the computing unit or the computing unit is integrated into the microcontroller and/or wherein the computing unit is configured to actuate the plurality of antenna elements, carry out the determination of the position and/or speed of the object in road traffic, and output an associated result(s) of the determination.

56. A vehicle having a radar unit designed according to claim 54.

57. A computer-readable storage medium, comprising a computer program, wherein the computer program, when run by a computing unit, prompts the computing unit to carry out the method claim 38.
